(19) United States
(12) Patent Application Publication
(10) Pub. No.: US 2014/0222211 A1
(43) Pub. Date: Aug. 7, 2014

(54) FAN SPEED CONTROL SYSTEM AND METHOD

(71) Applicant: HON HAI PRECISION INDUSTRY CO., LTD., New Taipei (TW)

(72) Inventor: CHAO-KE WEI, New Taipei (TW)

(21) Appl. No.: 13/922,698

(22) Filed: Jun. 20, 2013

(30) Foreign Application Priority Data
Feb. 5, 2013 (TW) 102104289

(51) Int. Cl. G05B 15/02

(52) U.S. Cl. CPC G05B 15/02
USPC 700/275

(57) ABSTRACT

A fan speed control system performed by a fan control board for controlling a fan shared by a number of servers in a server cabinet includes a instruction receiving module and a speed adjusting module. The instruction receiving module receives fan speed control instructions from the number of servers, wherein the fan speed control instructions consist of speedup instructions and slowdown instructions. The speed adjusting module responses to the fan speed control instructions to increase or decrease the speed of the fan by a preset value.

### BACKGROUND

1. Technical Field

Embodiments of the present disclosure relate to fan speed control systems and methods, and particularly, to fan speed control system and method for a fan shared by several severs in a server cabinet.

2. Description of Related Art

With the development of the cloud technology, more and more severs and server cabinets are needed. The energy-saving concern must be paid more attention when designing a new server cabinet. One of the energy-saving server cabinets decreases energy consumption by sharing one fan with a plurality of servers, and as such, a highly efficient fan control method and system are needed.

### BRIEF DESCRIPTION OF THE DRAWINGS

FIG. 1 is a schematic diagram of a fan speed control system operating environment.

FIG. 2 is a schematic block diagram of one embodiment of a fan speed control system.

FIG. 3 is a flowchart of one embodiment of a fan speed control method implemented by the fan speed control system of FIG. 2.

### DETAILED DESCRIPTION

The disclosure, including the accompanying drawings in which like references numerals indicate similar elements, is illustrated by way of example and not by way of limitation. It should be noted that references to “an” or “one” embodiment in this disclosure are not necessarily to the same embodiment, and such references can mean “at least one.”

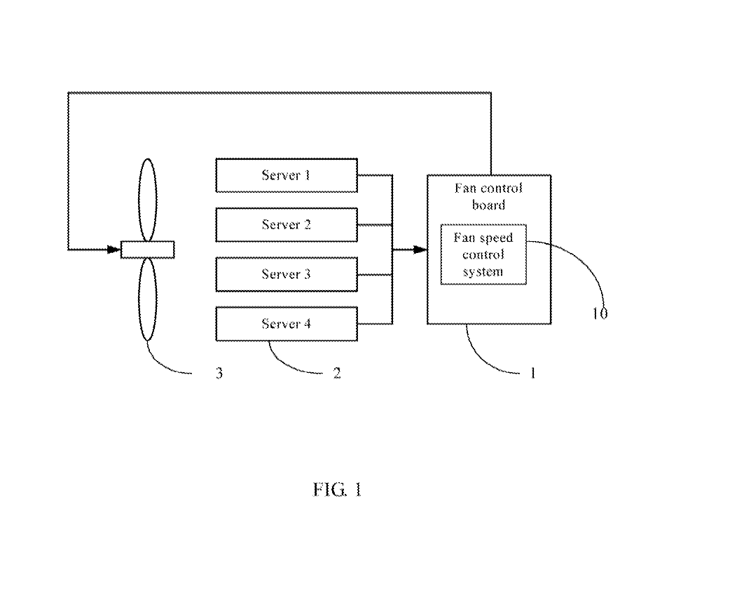

Referring to FIG. 1, a fan speed control system 10 is applied in a fan control board 1. The fan control board 1 is connected with a number of servers 2 and a fan 3 shared by the servers 2. The fan speed control system 10 is performed by the fan control board 1 and receives fan speed control instructions outputted by the servers 2 and adjusts the speed of the fan 3. When the fan speed control system 10 receives a speedup instruction from any one of the servers 2, the fan speed control system 10 increases the speed of the fan 3 by a preset value. When the fan speed control system 10 receives a slowdown instruction from any one of the servers 2, the fan speed control system 10 decreases the speed of the fan 3 by a preset value. In the embodiment, there are four servers 2. In other embodiments, the number of the servers 2 may be varied.

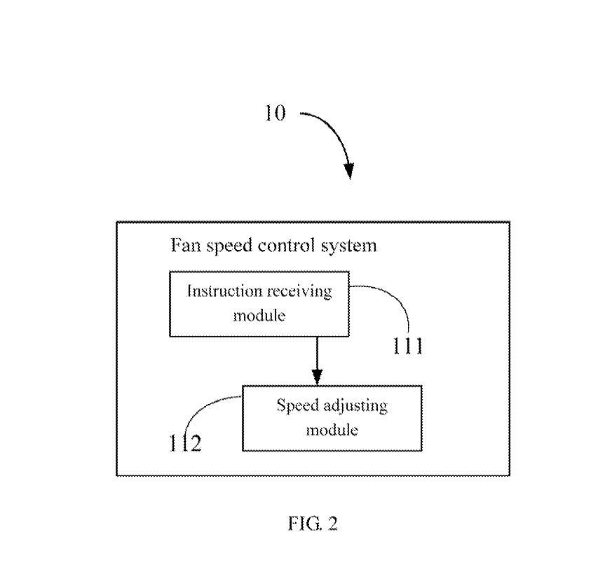

Referring to FIG. 2, the fan speed control system 10 includes a instruction receiving module 111 and a speed adjusting module 112. The instruction receiving module 111 receives fan speed control instructions from the severs 2. The speed adjusting module 112 adjusts the speed of the fan 3 in response to the fan control instructions from the severs 2.

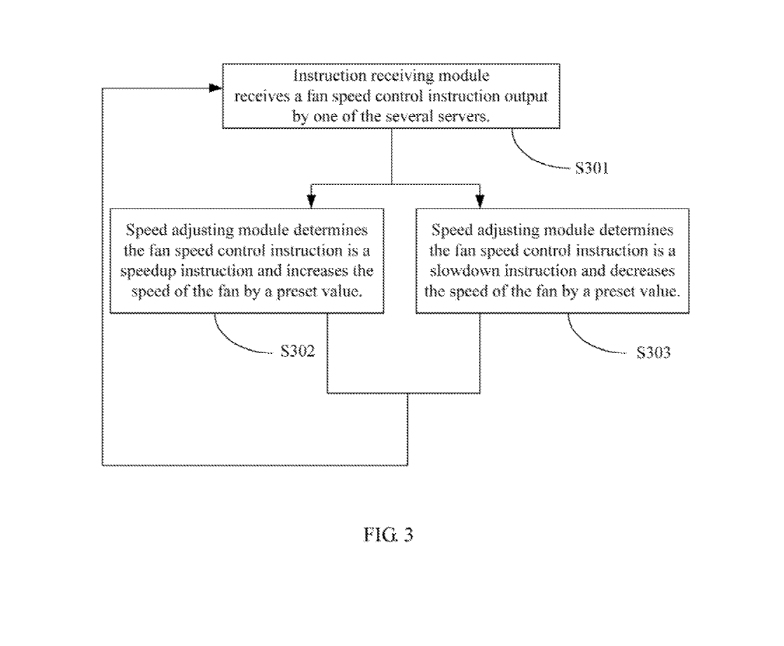

Referring to FIG. 3, a flow chart of a fan speed control method implemented by the fan speed control system in FIG. 2 is shown.

In the step S301, the instruction receiving module 111 receives a fan speed control instruction outputted by one of the servers 2.

In the step 302, when the speed adjusting module 112 determines that the fan speed control instruction is a speedup instruction, then the speed adjusting module 112 increases the speed of the fan 3 by a preset value. If the current speed of the fan 3 is the maximum speed, the speed adjusting module keeps the maximum speed unchanged.

In the step S303, when the speed adjusting module 112 determines that the fan speed control instruction is a slowdown instruction, then the speed adjusting module 112 decreases the speed of the fan 3 by a preset value. If the current speed of the fan 3 is the minimum speed, then the speed adjusting module 112 keeps the minimum unchanged.

In the embodiment, the fan speed control method may include another step S304: the speed adjusting module 112 set the maximum speed and the minimum speed of the fan 3 in response to a user input.

In the embodiment, for the speed adjusting module 112, the priority level of the speedup instruction is higher than the slowdown instruction. That is, when the instruction receiving module 111 receives more than one speed control instructions from different servers 2 at the same time and the speed adjusting module 112 determines the more than one speed control instructions include speedup instructions and slowdown instructions, the speed adjusting module 112 only responds to the speedup instructions and increases the speed of the fan 3 by a preset value. Furthermore, the speed adjusting module 112 disregards a slowdown instruction during controlling the fan to speed up, and the speed adjusting module 112 controls the fan to speed up if the instruction receiving module 111 receives a speedup instruction during the speed adjusting module 112 controls the fan 3 to slow down.

The servers 2 output fan speed control instructions according to their own temperatures.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

Although certain inventive embodiments have been specifically described, the present disclosure is not to be construed as being limited thereto. Various changes or modifications may be made to the present embodiments without departing from the scope and spirit of the present disclosure.

What is claimed is:

1. A fan speed control system for responding to fan speed control instructions output by a plurality of servers to control a fan shared by the plurality of servers, the fan speed control system comprising:
an instruction receiving module performed by a fan control board to receive fan speed control instructions output by the plurality of servers, wherein the fan speed control instructions comprise speedup instructions and slowdown instructions; and
a speed adjusting module performed by a fan control board to increase or decrease a speed of the fan by a preset value in response to the received fan speed control instructions;
wherein the speed adjusting module increases the speed of the fan by a preset value when the instruction receiving module receives a speedup instruction, and decreases the speed of the fan by a preset value when the instruction receiving module receives a slowdown instruction.

2. The fan speed control system of claim 1, wherein the fan adjusting module is configured to increase the speed of the fan by a preset value when the instruction receiving module receives a speedup instruction and a slowdown instruction at the same time.

3. The fan speed control system of claim 1, wherein the speed adjusting module disregards the slowdown instructions during controlling the fan to speed up.

4. The fan speed control system of claim 1, wherein the speed adjusting controls the fan to speed up if the instruction receiving module receives a speedup instruction during controlling the fan to slow down.

5. A fan speed control method implemented by the fan control system of claim 1, comprising:
the instruction receiving module receiving a fan speed control instruction;
the speed adjusting module increasing a speed of the fan by a preset value if the fan speed control instruction is a speedup instruction; and
the speed adjusting module decreasing the speed of the fan by a preset value if the fan speed control instruction is a slowdown instruction.

6. The fan speed control method of claim 5, further comprising:
the speed adjusting module increasing the speed of the fan by a preset value when the instructions receiving module receives a speedup instruction and a slowdown instruction at the same time.

7. The fan speed control method of claim 5, further comprising:
the speed adjusting module disregards the slowdown instructions during controlling the fan to speed up.

8. The fan speed control method of claim 5, further comprising:
the speed adjusting controls the fan to speed up if the instruction receiving module receives a speedup instruction during controlling the fan to slow down.
